(19) United States
(12) Patent Application Publication
(10) Pub. No.: US 2025/0065420 A1
(43) Pub. Date: Feb. 27, 2025

(54) Intelligent Saw Guides for a Saw Arbor Guide Assembly

(71) Applicant: PRECISION GUIDE MACHINERY AND REPAIR LIMITED, Prince George (CA)

(72) Inventors: Carrick Bergen, Prince George (CA); Nalynd Vogt, Prince George (CA); Nathan Pacholko, Prince George (CA); Michael Jones, Prince George (CA)

(21) Appl. No.: 18/815,011

(22) Filed: Aug. 26, 2024

Related U.S. Application Data
(60) Provisional application No. 63/534,495, filed on Aug. 24, 2023.

(51) Int. Cl. B23B 51/04

(52) U.S. Cl. CPC B23B 51/0473; B23B 2240/00

(57) ABSTRACT

In a saw arbor guide assembly, saw guides include a sensor and one or more connector units. The connector units may be proximate to one or both of the head surfaces, with the connector units receiving data from the sensor. The connector units communicate with other connector units located on adjacent saw guides within the stack. The communications comprise data received from the sensor. The primary and secondary guide manifolds are arranged at opposite ends of the stack. The primary and second guide manifolds include manifold connectors. The manifold connectors on the primary guide manifold communicate with the connector units on a first saw guide in the stack. The manifold connectors on the secondary guide manifold communicate with the connector units on a last saw guide in the stack. The server communicates with the manifold connectors in one or both of the primary guide manifold and the secondary guide manifold.

### CROSS-REFERENCE TO RELATED APPLICATIONS

This application claims the benefit of U.S. Provisional Patent Application No. 63/534,495 filed 24 Aug. 2023, the contents of which are hereby incorporated by reference.

### TECHNICAL FIELD

The present disclosure relates to saw arbor guide assemblies, and in particular, to saw guides for saw arbor guide assemblies.

### BACKGROUND

In a typical gang saw, a plurality of parallel circular saw blades are mounted on a rotating arbor to form a gang saw assembly. A saw arbor guide assembly is provided for each gang saw assembly. The saw arbor guide assembly comprises a plurality of saw guides attached to a guide post. The saw guides and the saw blades are configured such that each saw blade engages the saw guides in between two adjacent saw guides. The saw blades rotate at high speeds in order to cut logs into individual boards.

During operation, the saw blades may get quite hot. If a saw blade becomes too hot, there may be very adverse consequences to the general state of the equipment (i.e. the saw blades and/or the saw guides may become damaged) and to the quality of the resulting lumber product. In particular, high temperatures for extended periods of time may result in earlier than expected failure of the saw blades and/or the saw guides. Lubricants may be introduced to the saw blades in order to effect cooling of the saw blades.

It is known to install sensors on the saw guides in order to monitor various properties, including temperature and/or lubricant flow, relating to the saw blades during operation. However, the data collected by the sensors needs to be communicated to a computer for processing and analysis. The communications between the sensors and the computer may be conducted through wireless communications. However, such wireless communications may be inconsistent and unreliable, resulting in data loss or data corruption. Furthermore, such sensors typically require batteries for operation, and the batteries require periodic replacement. Also, in order to meaningfully monitor the various properties of the saw blades (including, for example, the temperatures thereof), the saw guides must be placed at specific locations so that the data collected can be associated with the specific saw blade(s) being monitored.

It is therefore an objective to provide a system for tracking and identifying a location of the saw guides in a saw guide assembly.

### SUMMARY

A saw arbor guide assembly comprises a plurality of physically connected, spatially aware, and intelligent saw guides that allows for multiple sensor configurations. Each saw guide that is connected is able to be identified and located within the stack of saw guides that form part of the saw arbor guide assembly. A variety of properties may be measured by sensors located on the saw guides, including, but not limited to, temperature, vibration, lubrication flow, etc. The identity and relative location of the saw guides from which the data is received can be determined accurately.

In one aspect, a saw arbor guide assembly comprises one or more arbors, one or more guide posts, a plurality of saw blades, a plurality of saw guides, a primary guide manifold, a secondary guide manifold, and a server. The plurality of saw blades are arranged about at least one of the one or more arbors. The plurality of saw guides are arranged about at least one of the one or more guide posts to form a stack of saw guides. Adjacent ones of the plurality of saw guides are configured to interact with the plurality of saw blades. Each of the saw guides comprises a head, a body, a sensor, and one or more connector units. The head is configured to engage with the at least one of the one or more guide posts, with the head comprising first and second head surfaces. The body is attached to the head and configured to extend, at least partially, between two of the plurality of saw blades. The sensor located on the body or the head. The one or more connector units located proximate to one or both of the first and second head surfaces, with the one or more connector units configured to receive data from the sensor. The one or more connector units are further configured to communicate with other ones of the connector units located on adjacent ones of the saw guides within the stack. The communications comprise the data received from the sensor. The primary and secondary guide manifolds are arranged at opposite ends of the stack, with each of the primary and secondary guide manifolds comprising one or more manifold connectors. The one or more manifold connectors on the primary guide manifold are configured to communicate with the one or more connector units on a first one of the saw guides in the stack. The one or more manifold connectors on the secondary guide manifold are configured to communicate with the one or more connector units on a last one of the saw guides in the stack. The server is configured to communicate with the one or more manifold connectors in one or both of the primary guide manifold and the secondary guide manifold.

In another aspect, each of the saw guides comprises two connector units, with a first one of the two connector units located proximate to the first head surface. A second one of the two connector units is located proximate to the second head surface.

In still another aspect, the first one of the two connector units is flush with the first head surface, and the second one of the two connector units is flush with the second head surface.

In a further aspect, communications between the one or more connector units and the other ones of the connector units located on the adjacent ones of the saw guides are through a wired connection.

In yet a further aspect, the wired connection comprises a pin-and-socket connection.

In a further aspect, communications between the one or more connector units and the other ones of the connector units located on the adjacent ones of the saw guides are through a wireless connection.

In a still further aspect, the wireless connection uses near-field communications.

In another aspect, communications between the manifold connectors on the primary guide manifold and the one or more connector units on the first one of the saw guides in the stack are through a wired connection.

In still another aspect, communications between the manifold connectors on the secondary guide manifold and the one or more connector units on the last one of the saw guides in the stack are through a wired connection.

In still yet another aspect, communications between the manifold connectors on the primary guide manifold and the one or more connector units on the first one of the saw guides in the stack are through a wireless connection.

In yet another aspect, communications between the manifold connectors on the secondary guide manifold and the one or more connector units on the last one of the saw guides in the stack are through a wireless connection.

In a further aspect, the server is further configured to generate a virtual model of the stack depicting an ordering of the plurality of saw guides in the stack based, at least in part, on the communications received from the one or more manifold connectors in one or both of the primary guide manifold and the secondary guide manifold.

In still a further aspect, the server is further configured to update the virtual model of the stack to include data received from the sensors on each of the plurality of saw guides in the stack.

In still yet a further aspect, the sensor is configured to detect one or more of the following properties: temperature, vibration, and lubricant flow.

In another aspect, a saw arbor guide assembly comprises an arbor, a guide post comprising one or more post connectors, a plurality of saw blades, a plurality of saw guides, and a server. The plurality of saw blades is arranged about the arbor. The plurality of saw guides is arranged about the guide post to form a stack of saw guides. Adjacent ones of the plurality of saw guides are configured to interact with the plurality of saw blades. Each of the saw guides comprises a head, a body, a sensor, and one or more connector units. The head is configured to engage with the at least one of the one or more guide posts. The body is attached to the head and configured to extend, at least partially, between two of the plurality of saw blades. The sensor is located on the body or the head. The one or more connector units are configured to receive data from the sensor and are further configured to communicate with one of the one or more post connectors when the plurality of saw guides are arranged in the stack. The communications comprise the data received from the sensor. The server is configured to communicate with the one or more post connectors.

In still another aspect, the server is further configured to generate a virtual model of the stack depicting an ordering of the plurality of saw guides in the stack based, at least in part, on the communications received from the one or more post connectors.

In another aspect, a method for operating a guide dresser comprises the steps of mounting a saw guide onto the guide dresser; providing a transmitter on an exterior of the saw guide; transmitting, by the transmitter, an identifier for the saw guide; receiving, by a scanner, the identifier; communicating, by the scanner, the identifier to a guide dresser server configured to control operations of the guide dresser; and verifying, by the guide dresser server, of the setting for operating the guide dresser based, at least in part, on the identifier.

In still another aspect, the transmitter comprises a radio frequency identification (RFID) tag. In still yet another aspect, the scanner comprises a RFID receiver.

The foregoing was intended as a summary only and of only some of the aspects of the invention. It was not intended to define the limits or requirements of the invention. Other aspects of the invention will be appreciated by reference to the detailed description of the preferred embodiments.

### BRIEF DESCRIPTION OF THE DRAWINGS

The invention will be described by reference to the detailed description of the embodiments and to the drawings thereof in which:

FIG. 1 depicts a saw arbor guide assembly according to one embodiment;

FIG. 2 depicts a top view of a saw guide of the saw arbor guide assembly;

FIG. 3 depicts a bottom view of a saw guide of the saw arbor guide assembly;

FIG. 4 depicts a saw guide of the saw arbor guide assembly;

FIG. 5 is a sectional view of FIG. 4, taken along A-A;

FIG. 6 is a sectional view of FIG. 4, taken along A-A, of another embodiment of the saw guide;

FIG. 7 depicts a portion of a stack of saw guides;

FIG. 8 depicts a sectional view of FIG. 7, taken along B-B;

FIG. 9 is another sectional view of FIG. 7, taken along B-B;

FIG. 10 is another sectional view of FIG. 7, taken along B-B, of another embodiment of the saw guide;

FIG. 11 depicts the primary guide manifold of the saw arbor guide assembly;

FIG. 12 depicts the secondary guide manifold of the saw arbor guide assembly;

FIG. 13 depicts a saw guide and a portion of the guide post of the saw arbor guide assembly according to another embodiment;

FIG. 14 depicts a portion of the guide post of the saw arbor guide assembly according to another embodiment;

FIG. 15 depicts a saw guide and a portion of the guide post of the saw arbor guide assembly according to another embodiment;

FIG. 16 depicts a saw guide and a portion of the guide post of the saw arbor guide assembly according to yet another embodiment;

FIG. 17 depicts a saw guide and a portion of the stopper bar of the saw arbor guide assembly according to another embodiment;

FIG. 18 is another view of the embodiment of FIG. 17;

FIG. 19 depicts a portion of a stack of saw guides according to another embodiment;

FIG. 20 depicts a saw guide of the saw arbor guide assembly according to another embodiment;

FIG. 21 depicts a portion of a stack of saw guides according to the embodiment of FIG. 20;

FIG. 22 depicts a guide dresser according to another embodiment;

FIG. 23 depicts a portion of the guide dresser of FIG. 22;

FIG. 24 depicts a saw guide of the saw arbor guide assembly according to another embodiment; and

FIG. 25 depicts a saw guide of the saw arbor guide assembly according to yet another embodiment.

### DETAILED DESCRIPTION

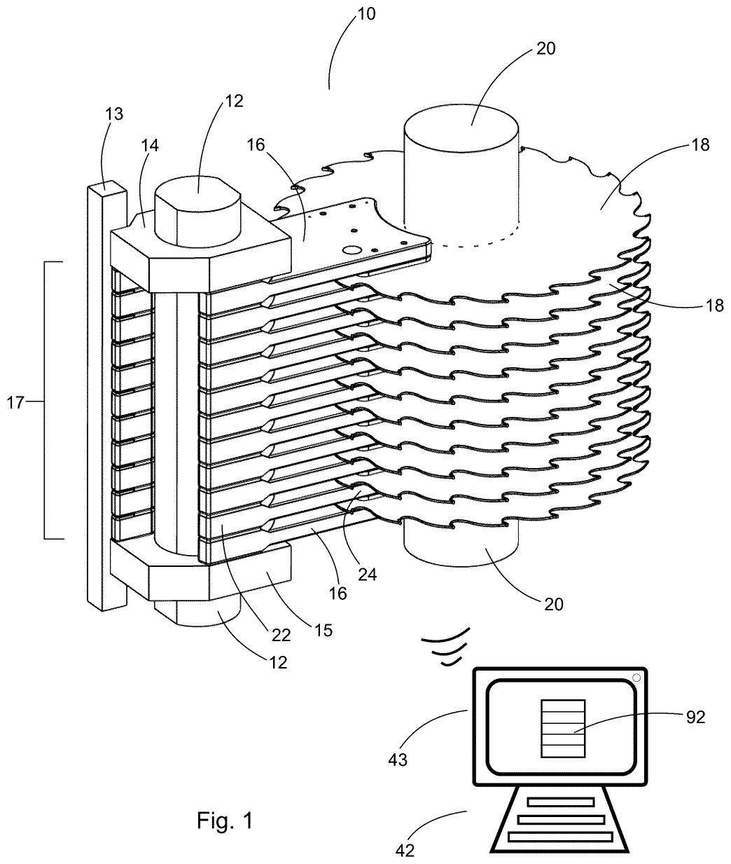

Referring to FIG. 1, in some embodiments, a saw arbor guide assembly 10 comprises a guide post 12 and a plurality of saw guides 16 mounted, at least partially, about the guide post 12. Primary and secondary guide manifolds 14, 15 may also be mounted on the guide post 12. The guide post 12 may be substantially cylindrical in shape, but other shapes and configurations for the guide post 12 may also be possible. The plurality of saw guides 16 may be arranged, generally as a stack 17, about the guide post 12, such as between the primary and secondary guide manifolds 14, 15, as shown in FIG. 1. The location and spacing of the saw guides 16 are such so as to allow them to interact with one or more saw blades 18 that are attached to a rotating arbor 20 during cutting operation. In particular, the saw guides 16 may be arranged such that one of the saw blades 18 travels in between two adjacent ones of the saw guides 16 during operation.

The saw arbor guide assembly 10 depicted in FIG. 1 is an example of a vertical single arbor (VSA) configuration (with a single set of saw guides 16 and a single set of saw blades 18 arranged vertically). It is understood that other configurations are also possible, such as a vertical double arbor (VDA) configuration (with two sets of saw guides 16 and two sets of saw blades 18 arranged vertically), a horizontal single arbor (HSA) configuration (with a single set of saw guides 16 and a single set of saw blades 18 arranged horizontally), a horizontal double arbor (HDA) configuration (with two sets of saw guides 16 and two sets of saw blades 18 arranged horizontally), and a quad configuration (with four sets of saw guides 16 and four sets of saw blades 18 arranged horizontally or in some other configuration).

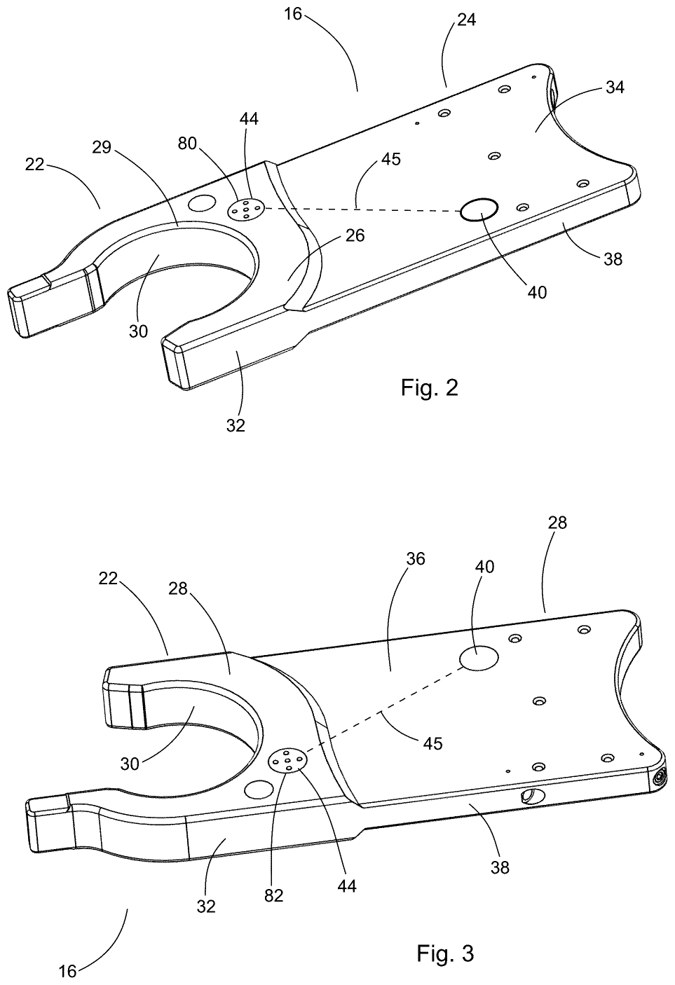

FIGS. 2 and 3 depicts an embodiment of one of the saw guides 16. The saw guide 16 comprises a head 22 and a body 24, with the head 22 attached to the body 24. In some embodiments, the head 22 and the body 24 are integrally attached or integrally formed. The head 22 is adapted to attach to the guide post 12, such as by, defining a collar 29 that, at least partially, extends around the guide post 12. The body 24 is adapted to, in conjunction with adjacent ones of the saw guides 16, interact with one or more of the saw blades 18. For example, each one of the saw blades 18 may be configured to rotate or spin between adjacent ones of the saw guides 16. As shown in FIG. 1, one or more of the bodies 24 of the saw guides 16 may extend, at least partially, in between adjacent ones of the saw blades 18.

In some embodiments, the head 22 and the body 24 may be delineated by a change in thickness, such that the head 22 has a greater thickness than the body 24, as shown in FIGS. 2 and 3.

The head 22 comprises first and second head surfaces 26, 28. The head 22 further comprises a collar sidewall 30 extending between the first and second head surfaces 26, 28. The collar sidewall 30 is adapted to engage with the guide post 12 when the saw guide 16 is attached to the guide post 12. The head 22 further comprises a head sidewall 32 extending between the first and second head surfaces 26, 28. The head sidewall 32 extends substantially along an exterior perimeter of the head 22. The collar sidewall 30 may be substantially continuous with, and connected to, the head sidewall 32.

The body 24 comprises first and second body surfaces 34, 36, with a body sidewall 38 extending between the first and second body surfaces 34, 36. The body sidewall 38 extends substantially along a perimeter of the body 24. The body sidewall 38 may be substantially continuous with, and connected to, the head sidewall 32.

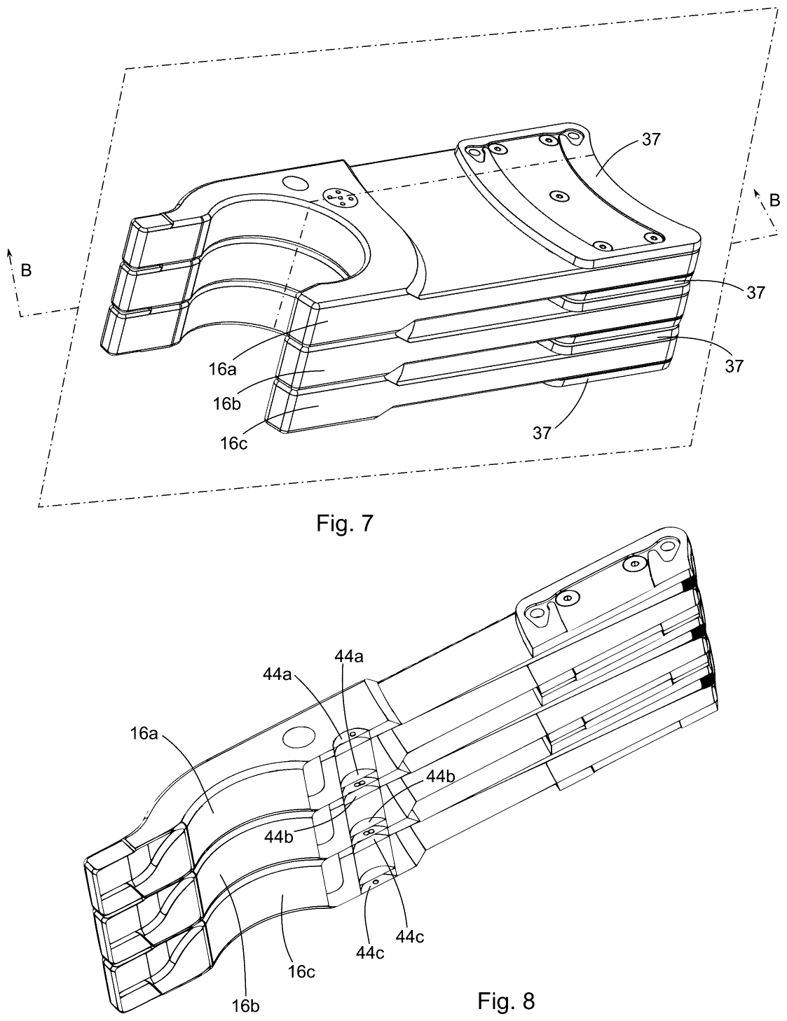

One or both of the first and second body surfaces 34, 36 may be adapted to accommodate a support pad 37 for interacting with the saw blades 18, as shown in FIG. 7. The support pad 37 may be made from Babbitt material.

In order to monitor a property of the saw guide 16 (e.g. temperature, vibration, lubricant flow, etc.), one or more sensors 40 may be installed on the saw guide 16. In some embodiments, the sensors 40 may be located on or within the body 24. For example, the sensors 40 may be placed in channels extending through the body 24. In other embodiments, the sensors 40 may be located on or within the head 22. For example, the sensors 40 may be placed in channels extending through the head 22. A server 42 is provided that is configured to receive data from the sensors 40 on the saw guides 16. The data may be transmitted or communicated to the server 42 in one of several ways.

In one embodiment, the saw guides 16 may further comprise one or more connector units 44 located on the saw guides 16. The connector units 44 may be located on the head 22 and may be configured to provide communications and/or relay electrical power, as described later. The connector units 44 may comprise processing capabilities, including processing and transmitting messages.

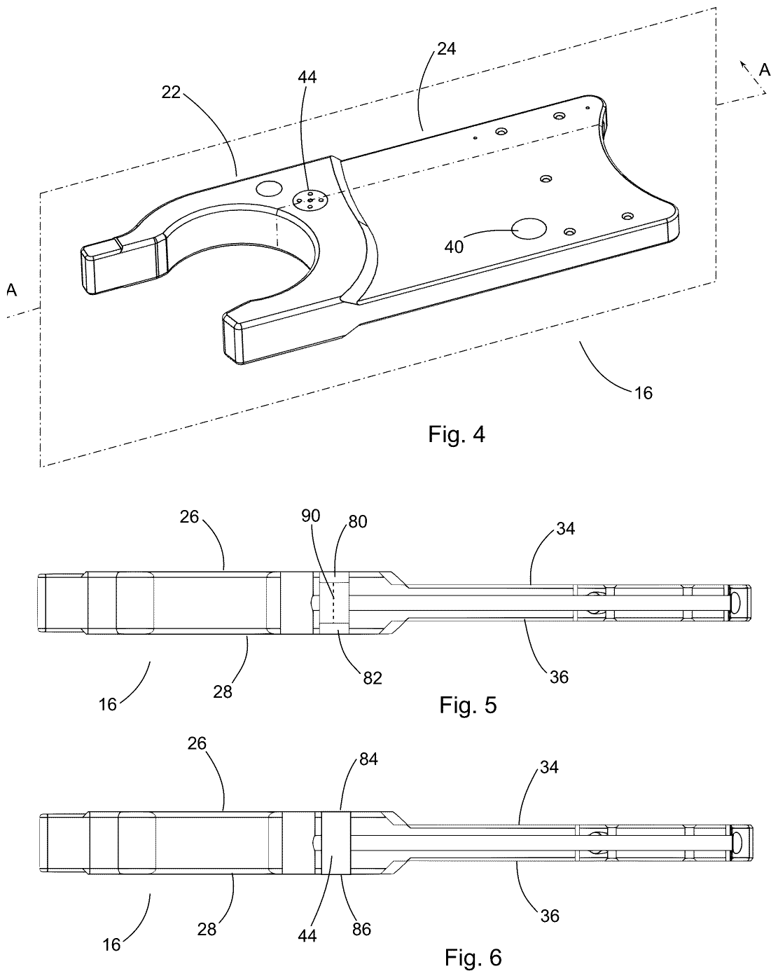

For example, in some embodiments, the connector units 44 may comprise first and second connector units 80, 82, with the first connector unit 80 located proximate to the first head surface 26 and the second connector unit 82 located proximate to the second head surface 28, as shown in FIGS. 4 and 5. In some embodiments, the first and second connector units 80, 82 may be placed in channels formed on the first and second head surfaces 26, 28, respectively. The first connector unit 80 may be substantially flush with the first head surface 26, and the second connector unit 82 may be substantially flush with the second head surface 28. In other embodiments, the first and second connector units 80, 82 may be embedded on the first and second head surfaces 26, 28, respectively. The first and second connector units 80, 82 may be connected to each other (such as through connector wiring 90 extending within the head 22), or the first and second connector units 80, 82 may be configured to wirelessly communicate with each other.

In other embodiments, referring to FIGS. 4 and 6, the connector units 44 may extend substantially through the head 22, with the connector units 44 comprising a first connector surface 84 extending proximate to the first head surface 26 and a second connector surface 86 extending proximate to the second head surface 28. In other words, in such embodiments, instead of the connector units 44 comprising separate first and second connector units 80, 82, the connector units 44 extend through substantially an entire height of the saw guide 16, with the first connector surface 84 corresponding to the first connector unit 80 and the second connector surface 86 corresponding to the second connector unit 82.

The connector units 44 are configured to communicate with the connector units 44 on an adjacent one of the saw guides 16. The connector units 44 on each of the saw guides 16 are in communications with the sensors 40 on the saw guide 16. For example, sensor wiring 45 may be provided to connect the connector units 44 with the sensors 40 so that data from the sensors 40 can be transmitted to the connector units 44. Alternatively, in some embodiments, the connector units 44 may communicate wirelessly with the sensors 40.

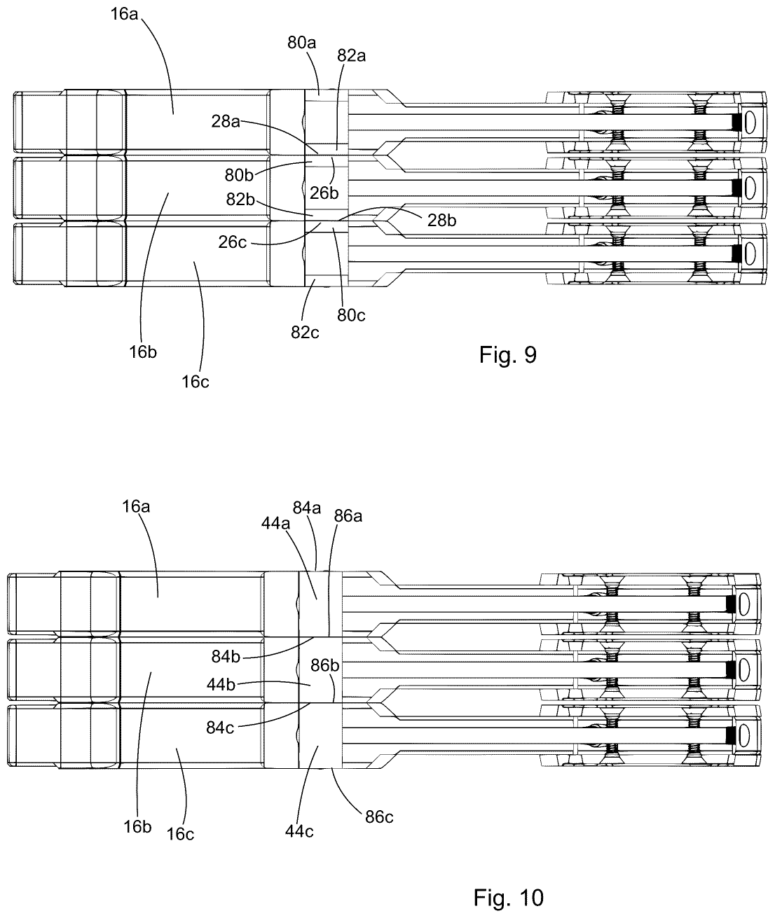

FIGS. 7 to 10 depicts one possible arrangement of three of the saw guides 16 (16a, 16b, 16c) that may form part of the stack 17. Referring to FIGS. 8 and 9, the saw guide 16a comprises the connector units 44a, which in turn comprises the first and second connector units 80a, 82a. The second connector unit 82a proximate to the second head surface 28a of the saw guide 16a is configured to communicate with the first connector unit 80b (of the connector units 44b) proximate to the first head surface 26b of the saw guide 16b. The second connector unit 82b (of the connector units 44b) proximate to the second head surface 28b of the saw guide 16b is configured to communicate with the first connector unit 80c (of the connector units 44c) proximate to the first head surface 26c of the saw guide 16c. Similar communications may be conducted with other ones of the saw guides 16 both above and/or below the three saw guides 16a, 16b, 16c. For example, the second connector unit 82c may be configured to communicate with the saw guide 16 directly below it in the stack 17.

Referring to FIG. 10, where the connector units 44 extend substantially through the head 22, the connector unit 44a of the saw guide 16a comprises the first and second connector surfaces 84a, 86a. The second connector surface 86a is configured to communicate with the first connector surface 84b of the saw guide 16b. The second connector surface 86b of the saw guide 16b is configured to communicate with the first connector surface 84c of the saw guide 16c. Similar communications may be conducted with other ones of the saw guides 16 both above and/or below the three saw guides 16a, 16b, 16c. For example, the second connector surface 86c may be configured to communicate with the saw guide 16 directly below it in the stack 17.

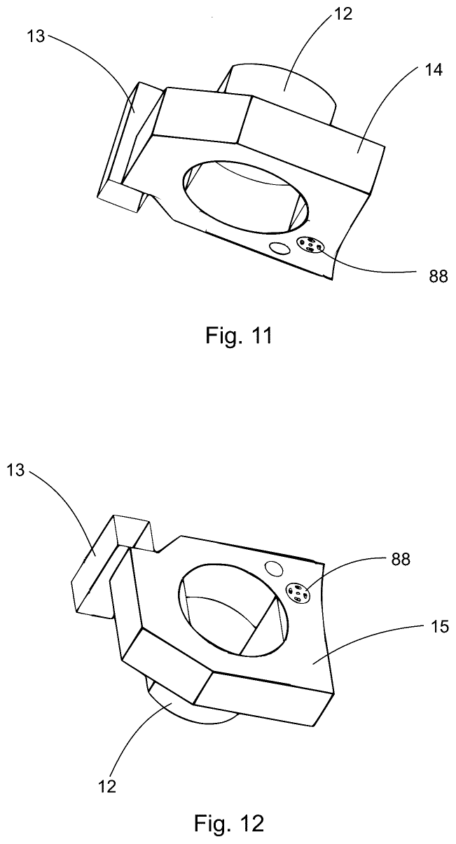

In this manner, the connector units 44 for each of the saw guides 16 are able to communicate with the connector units 44 on adjacent ones of the saw guides 16. The saw guides 16 that are located at the upper and lower ends of the stack 17 are able to communicate with the primary or secondary guide manifolds 14, 15. For example, referring to FIGS. 11 and 12, the primary and secondary guide manifolds 14, 15 may comprise manifold connectors 88. The manifold connector 88 on the primary guide manifold 14 may be configured to communicate with the first connector unit 80 on the first head surface 26 of the uppermost one of the saw guides 16. Similarly, the manifold connector 88 on the secondary guide manifold 15 may be configured to communicate with the second connector unit 82 on the second head surface 28 of the lowermost one of the saw guides 16.

Similarly, where the connector heads 44 extend substantially through the head 22, the manifold connector 88 on the primary guide manifold 14 may be configured to communicate with the first connector surface 86 of the uppermost one of the saw guides 16. The manifold connector 88 on the secondary guide manifold 15 may be configured to communicate with the second connector surface 86 of the lowermost one of the saw guides 16.

The manifold connectors 88 on the primary and secondary guide manifolds 14, 15 may be configured to communicate with the server 42, such as through wired or wireless communications.

The communication between the connector units 44 on adjacent ones of the saw guides 16 may take one of several forms. In some embodiments, the connector units 44 on adjacent ones of the saw guides 16 may communicate through direct electrical contact (e.g. a wired connection). By way of example only, the connector units 44 on adjacent ones of the saw guides 16 may comprise pin-and-socket connectors that are configured to physically engage with each other and provide a direct communications connection between the connector units 44. Other mechanisms for providing direct contact communications between the connector units 44, such as through other mateable or engagement connections, may also be utilized.

In other embodiments, each of the connector units 44 is configured to wirelessly communicate with another one of the connector units 44, such as through near-field communication (NFC) or some other suitable short range communications protocol. Utilizing short range communications may improve reliability of the communications. For example, the connector units 44 on adjacent ones of the saw guides 16 may be configured to wirelessly communicate with each other.

In still other embodiments, the connector units 44 on adjacent ones of the saw guides 16 may be configured to engage with each other through wireless infrared communications.

It is understood that other forms of short range or direct contact communications may also be used.

For example, in the embodiment shown in FIG. 9, the second connector unit 82a of the saw guide 16a may communicate with the first connector unit 80b of the saw guide 16b through pin-and-socket connectors. Alternatively, the second connector unit 82a may communicate with the first connector unit 80b using NFC or through wireless infrared communications.

The communications between the manifold connectors 88 and the connector units 44 may be similar to the communications between the connector units 44 on adjacent ones of the saw guides 16 (i.e. through direct electrical contact or through wireless communications).

In some embodiments, in addition to using the connections between the connector units 44 and the connections between the connector units 44 and the manifold connectors 88 for data communications, the connections may also be used to supply electrical power. For example, where the connections between the connector units 44 and the connections between the connector units 44 and the manifold connectors 88 are through direct electrical contact, these connections may be used to transmit electrical power through the stack 17. The electrical power may be used to power the connector units 44, such as by transmission of electrical power through the connector wiring 90. In addition, or alternatively, the electrical power may also be used to power the sensors 40, such as by transmission of electrical power through the sensor wiring 45.

The saw guides 16 may be assembled into the stack 17 in between the primary and secondary guide manifolds 14, 15. The saw guides 16 may be clamped together to form the stack 17 and placed between the primary and secondary guide manifolds 14, 15. Once clamped, the server 42 is configured to cause the manifold connector 88 on the primary guide manifold 14 to transmit a message and/or relay electrical power to the first connector unit 80 (on the first head surface 26) of the uppermost one of the saw guides 16. The receipt of the message and/or electrical power by the first connector unit 80 of the uppermost one of the saw guides 16 may cause the first and second connector units 80, 82 on the uppermost one of the saw guides 16 to power up. This in turn causes the second connector unit (on the second head surface 28) of the uppermost one of the saw guides 16 to transmit the message and/or relay electrical power to the adjacent one of the saw guides 16 (i.e. the second uppermost one of the saw guides 16).

In this manner, the connector units 44 on successive ones of the saw guides 16 are powered up (through the transmission of the message and/or the relay of electrical power) along the stack 17), until the second connector unit 82 on the second head surface 28 of the lowermost one of the saw guides 16 transmits the message to the manifold connector 88 on the secondary guide manifold 15. The manifold connector 88 on the secondary guide manifold 15 is then configured to transmit the message to the server 42.

As the message is transmitted down along the stack 17 by the respective ones of the connector units 44, the respective ones of the connector units 44 may amend the message to include identifiers to identify the respective ones of the saw guides 16 in the stack 17 and/or their relative positions within the stack 17. For example, after the first connector unit 80 on the uppermost one of the saw guides 16 receives the message from the manifold connector 88 on the primary guide manifold 14, the message may be amended by the first or second connector units 80, 82 to include an identifier for the uppermost one of the saw guides 16 and/or to include an indication that it is the uppermost one of the saw guides 16. The (amended) message may be then be transmitted by the second connector unit 82 to the first connector unit 80 on the second uppermost one of the saw guides 16. The message may then be further amended to include an identifier for the second uppermost one of the saw guides 16 and/or to include an indication that it is the second uppermost one of the saw guides 16.

The message transmitted from the manifold connector 88 on the secondary guide manifold 15 to the server 42 may accordingly include information on identifiers for all of the saw guides 16 in the stack 17 and the relative positions of all of the saw guides 16 within the stack 17. Based, at least in part, on the message received from the manifold connector 88 on the secondary guide manifold 15, the server 42 may be configured to generate a virtual model 92 of the stack 17. The virtual model 92 may be a representation of the stack 17 that maps the relative locations and/or ordering of each of the saw guides 16 in the stack 17 and the identifiers for each of the saw guides 16 in the stack 17. The server 42 may be further configured to display the virtual model 92 on a display screen 43 to the user, as shown in FIG. 1.

It is understood that other mechanisms for transmitting the message or

messages along the stack 17 may be used. By way of example only, the messages may be transmitted through the connector units 44 using a Controller Area Network (CAN) bus or through daisy-chaining of the connector units 44.

It is also understood that instead of transmitting the messages from the primary guide manifold 14 along the stack 17 to the secondary guide manifold 15, it is also possible to start from the secondary guide manifold 15 and transmit messages upwards along the stack 17 to the primary guide manifold 14.

After the virtual model 92 has been generated by the server 42, data from one or more of the sensors 40 may be transmitted to the server 42 through messages sent along the stack 17 by the connector units 44. For example, for a particular one of the saw guides 16, the sensor 40 may transmit data regarding the property (e.g. temperature, vibration, etc.) being sensed to one or both of the first and second connector units 80, 82. In some embodiments, the second connector unit 82 may be configured to transmit a message to the first connector unit 80 on a successive one of the saw guides 16. The message may include an identifier for the particular one of the saw guides 16 and the data regarding the property being sensed by the sensor 40. The message may then be propagated along the stack 17 until it reaches the manifold connector 88 on the secondary guide manifold 15, which in turns transmits the message to the server 42 for processing. Based on the information in the message, the server 42 is able to determine the data from the sensor 40 and from which of the saw guides 16 the data is transmitted. This information may be incorporated into the virtual model 92 by the server 42.

In other embodiments, messages may be periodically sent along or propagated along the stack 17. The messages may be sent at pre-configured fixed intervals of time.

When one of these messages is received by a particular one of the saw guides 16, the first or second connector units 80, 82 may be configured to amend the message to include an identifier for the particular one of the saw guides 16 and the data regarding the property being sensed by the sensor 40. The second connector unit 82 may then be configured to transmit the (amended) message to the first connector unit 80 on a successive one of the saw guides 16. The message may then be propagated along the stack 17. The message may be further amended one or more times as it is propagated along the stack 17, such as by other ones of the saw guides 16 to include their identifiers and to include data regarding the property being sensed by the sensors 40 on the other ones of the saw guides 16. When the message reaches the manifold connector 88 on the secondary guide manifold 15, the manifold connector 88 is configured to transmit the message to the server 42 for processing. Based on the information in the message, the server 42 is able to determine the data from the sensors 40 and from which ones of the saw guides 16 the data is transmitted. This information may be incorporated into the virtual model 92 by the server 42.

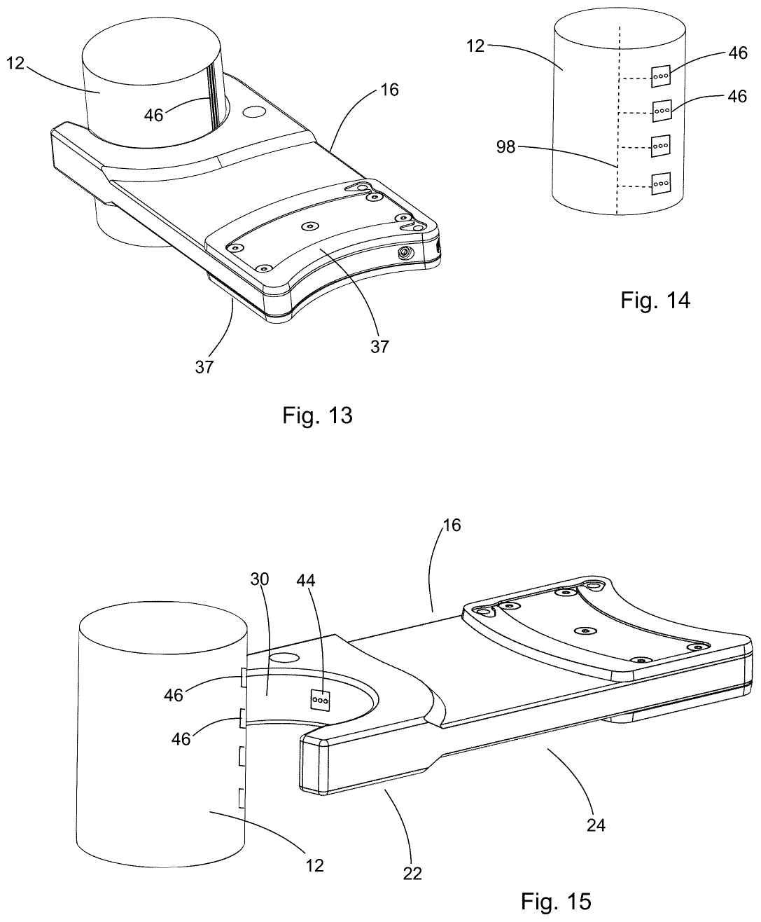

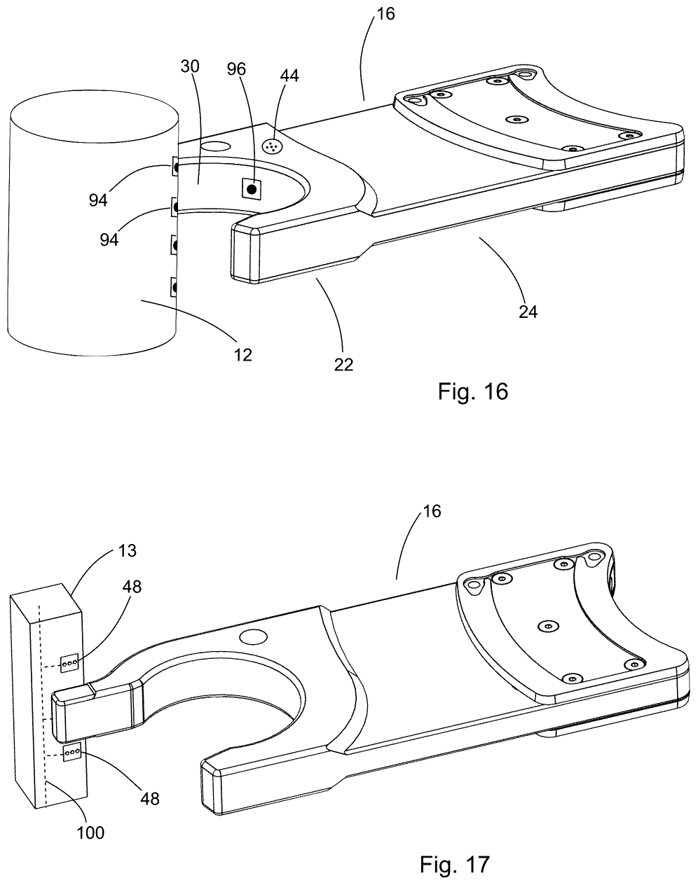

In another embodiment, instead of serial communications between successive ones of the saw guides 16 along the stack 17, each of the saw guides 16 may instead communicate with the guide post 12. Referring to FIGS. 13 to 15, in this embodiment, each of the saw guides 16 comprises the connector unit 44; however, the connector unit 44 is located on the collar sidewall 30. Furthermore, in this embodiment, the guide post 12 comprises one or more post connectors 46 located on an exterior surface thereof. The post connectors 46 may be electrically connected to each other, such as through post wiring 98, as shown in FIG. 14. The post wiring 98 may be located on the outside or the inside of the guide post 12, or a combination of both. The post connectors 46 are configured to communicate with the connector units 44 on the saw guides 16 when the saw guides 16 are assembled into the stack 17. For example, in some embodiments, the number of the post connectors 46 may be equal to the number of saw guides 16 in the stack 17, such that each connector unit 44 communicates with one of the post connectors 46 (as shown in FIG. 15). Alternatively, one of the post connectors 46 may be configured to communicate with one or more of the connector units 44 (as shown in FIG. 13).

The communication between the connector units 44 and the post connectors 46 may take one of several forms. In some embodiments, the connector units 44 may communicate with the post connectors 46 through direct electrical contact (e.g. a wired connection). By way of example only, the connector units 44 and the post connectors 46 may comprise pin-and-socket connectors that are configured to physically engage with each other and provide a direct communications connection between the connector units 44 and the post connectors 46. Other mechanisms for providing direct contact communications between the connector units 44 and the post connectors 46, such as through other mateable or engagement connections, may also be utilized.

In other embodiments, the connectors units 44 may be configured to wirelessly communicate with the post connectors 46, such as through NFC or some other suitable short range communications protocol. Utilizing short range communications may improve reliability of the communications. In still other embodiments, the connector units 44 may be configured to engage with the post connectors 46 through wireless infrared communications. It is understood that other forms of short range or direct contact communications may also be used.

The post connectors 46 are in communications with the server 42. The server 42 may be configured to generate the virtual model 92 of the stack 17 by mapping the relative locations of the saw guides 16 in the stack 17 based, at least in part, on which of the post connectors 46 communicate with which of the connector units 44. The server 42 may also be configured to display the virtual model 92 on the display screen 43 to the user.

Data from one or more of the sensors 40 may be transmitted to the server 42 through messages sent from the connector units 44 to the post connectors 46. The server 42 is able to determine from which of the saw guides 16 the data is transmitted based, for example, on which of post connectors 46 the data from the connector units 44 is received.

Alternatively, the guide post 12 may be used as a power source for the saw guides 16. For example, referring to FIG. 16, instead of the port connectors 46 on the guide post 12 and the connector units 44 located on the collar wall 30, the guide post 12 may comprise one or more post power connectors 94 located on an exterior surface thereof. Each of the saw guides 16 comprises one or more guide power connectors 96 located on the collar sidewall 30. The post power connectors 94 are configured to contact or engage with the guide power connectors 96 on the saw guides 16 when the saw guides 16 are assembled into the stack 17. Data communications may be carried out using the connector units 44 on the first and second head surfaces 26, 28, similar to what was described above. Alternatively, data communications may be transmitted between the sensors 40 and the server 42 using wireless communication systems.

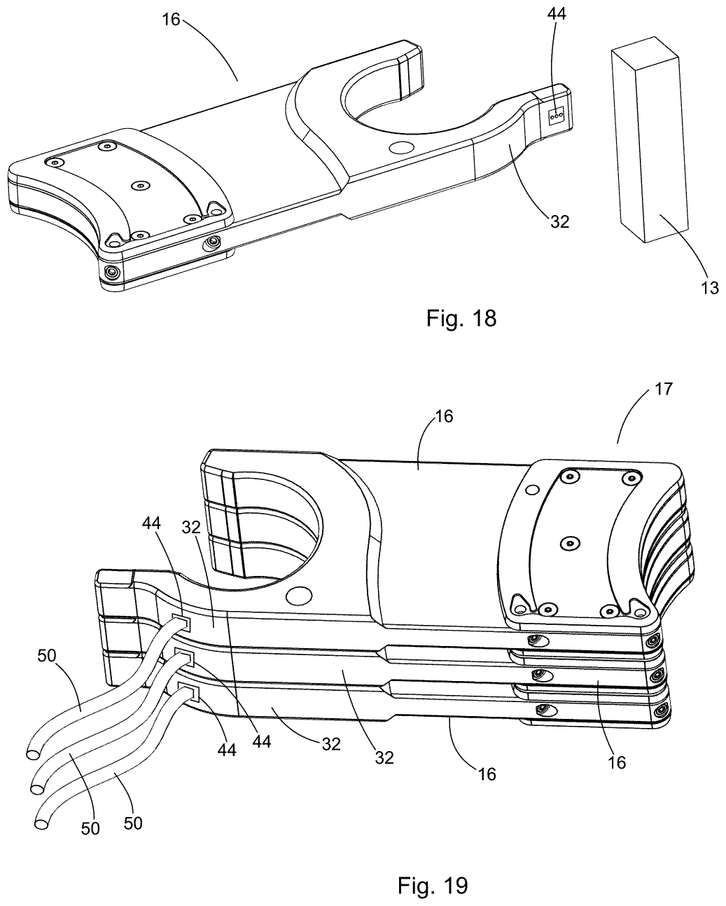

In still another embodiment, the saw arbor guide assembly 10 further comprises a stopper bar 13 extending substantially parallel to the guide post 12 (as shown in FIG. 1). The stopper bar 13 may be configured to engage with the primary and secondary guide manifolds 14, 15 and with the saw guides 16. Referring to FIGS. 18 and 19, in this embodiment, each of the saw guides 16 comprises the connector unit 44; however, the connector unit 44 is located on the head sidewall 32. Furthermore, in this embodiment, the stopper bar 13 comprises one or more bar connectors 48 located on an exterior surface thereof. The bar connectors 48 may be electrically connected to each other, such as through bar wiring 100. The bar wiring 100 may be located on the outside or the inside of the stopper bar 13, or a combination of both. The bar connectors 48 are configured to communicate with the connector units 44 on the saw guides 16 when the saw guides 16 are assembled into the stack 17. The number of the bar connectors 48 may be equal to the number of saw guides 16 in the stack 17, such that each connector unit 44 communicates with one of the bar connectors 48. Alternatively, one of the bar connectors 48 may be configured to communicate with more than one of the connector units 44.

The communication between the connector units 44 and the bar connectors 48 may take one of several forms. In some embodiments, the connector units 44 may communicate with the bar connectors 48 through direct electrical contact (e.g. a wired connection). By way of example only, the connector units 44 and the bar connectors 48 may comprise pin-and-socket connectors that are configured to physically engage with each other and provide a direct communications connection between the connector units 44 and the bar connectors 48. Other mechanisms for providing direct contact communications between the connector units 44 and the bar connectors 48, such as through other mateable or engagement connections, may also be utilized.

In other embodiments, the connector units 44 may be configured to wirelessly communicate with the bar connectors 48, such as through NFC or some other suitable short range communications protocol. Utilizing short range communications may improve reliability of the communications. In still other embodiments, the connector units 44 may be configured to engage with the bar connectors 48 through wireless infrared communications. It is understood that other forms of short range or direct contact communications may also be used.

The bar connectors 48 are in communications with the server 42. The server 42 may be configured to generate the virtual model 92 of the stack 17 by mapping the relative locations of the saw guides 16 in the stack 17 based, at least in part, on which of the bar connectors 48 communicate with which of the connector units 44. The server 42 may also be configured to display the virtual model 92 on the display screen 43 to the user.

Data from one or more of the sensors 40 may be transmitted to the server 42 through messages sent from the connector units 44 to the bar connectors 48. The server 42 is able to determine from which of the saw guides 16 the data is transmitted based, for example, on which of bar connectors 48 the data from the connector units 44 is received.

In still yet another embodiment, referring to FIG. 19, a plurality of wires 50 is provided, with one end of each of the wires 50 connected to one of the saw guides 16. The other end of the wires 50 may be electrically connected to the server 42. Each of the saw guides 16 comprises the connector unit 44; however, in this embodiment, the connector unit 44 is configured to connect with one of the wires 50. The connector unit 44 may be located on the head sidewall 32.

The server 42 is configured to generate the virtual model 92 of the stack 17 by mapping the relative locations of the saw guides 16 in the stack 17 based, at least in part, on which of the wires 50 is electrically connected with which of the connector units 44. The server 42 may also be configured to display the virtual model 92 on the display screen 43 to the user.

Data from one or more of the sensors 40 may be transmitted to the server 42 through messages sent from the connector units 44 through the wires 50. The server 42 is able to determine from which of the saw guides 16 the data is transmitted based, for example, on which of the wires 50 the data from the connector units 44 is transmitted through.

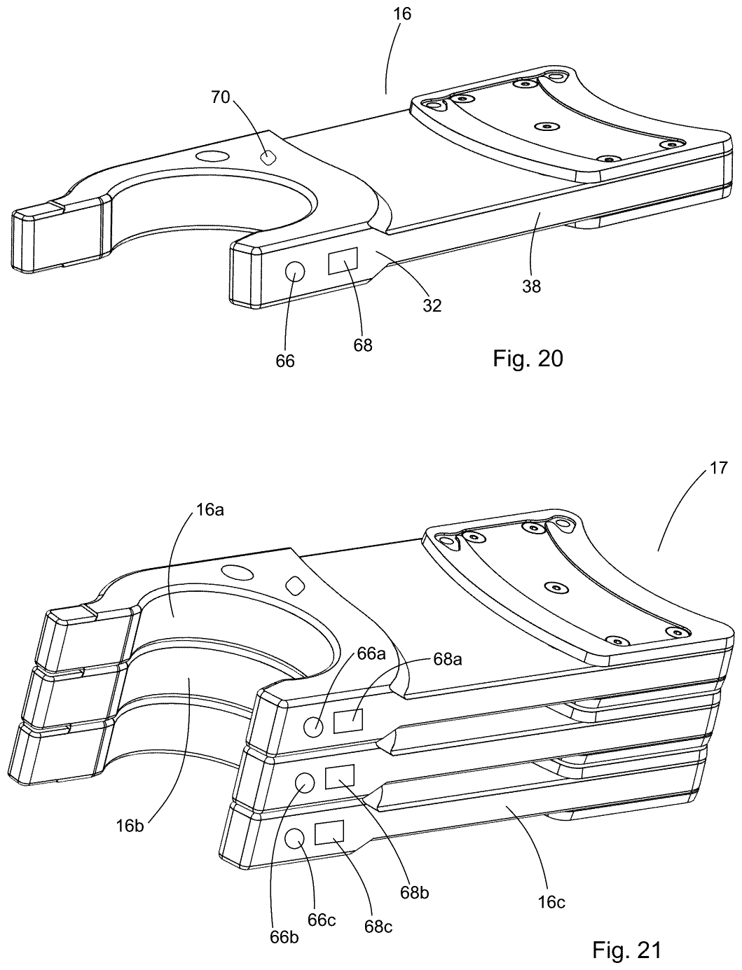

In another embodiment, referring to FIGS. 20 and 21, each of the saw guides 16 may further comprise a switch 66 located on an exterior of the saw guide 16 and a transceiver 70, which may be capable of wireless communications with the server 42. The switch 66 may be located on the head sidewall 32 or on the body sidewall 38 of the saw guide 16. Each of the saw guides 16 may further comprise a display 68 also located on an exterior of the saw guide 16. The display 68 may also be located on the head sidewall 32 or on the body sidewall 38. The display 68 may be a digital or analog display. The switch 66 may be a push-button switch, a toggle switch, or any other suitable type of control mechanism.

When the saw guides 16 are arranged in the stack 17, as shown, for example, in FIG. 21, the user is able to activate the switch 66a on a first one of the saw guides 16 (e.g. the uppermost one of the saw guides 16, shown as the saw guide 16a in FIG. 21). Where the switch 66a is a push-button switch, the user may be able to activate the switch 66a by pressing on it. When the switch 66a is activated, the saw guide 16a is configured to wirelessly communicate with the server 42 using the transceiver 70. The saw guide 16a may also be configured to transmit a message to the server 42 comprising information regarding an identifier of the saw guide 16a. The saw guide 16a may also be configured to receive an acknowledgment from the server 42. The display 68a may be configured to illuminate or otherwise indicate that the saw guide 16a has successfully connected with the server 42 (e.g. the saw guide 16a has received the acknowledgement from the server 42 or has otherwise been able to successfully communicate with the server 42).

The user may then activate the switch 66b on a second one of the saw guides 16 (e.g. the second uppermost one of the saw guides 16, shown as the saw guide 16b in FIG. 21). When the switch 66b is activated, the saw guide 16b is configured to wirelessly communicate with the server 42. The display 68b may be configured to illuminate or otherwise indicate that the saw guide 16b has successfully connected with the server 42.

Similarly, the user may next activate the switch 66c on the saw guide 16c. Once the saw guide 16c has successfully connected with the server 42, the display 68c may be configured to illuminate.

In this manner, the user is able to sequentially activate the switches 66 on the saw guides 16 until all of the saw guides 16 in the stack 17 have successfully communicated with the server 42. Based, at least in part, on the communications received from the saw guides 16 by the server 42, the server 42 is able to determine the relative positioning and identities of the saw guides 16 in the stack 17.

The server 42 is configured to generate the virtual model 92 of the stack 17 by mapping the relative locations of the saw guides 16 based, at least in part, on the content of the messages received from the saw guides 16 from the transceivers 70 during activation. For example, the server 42 may be able to determine that the first message received from the saw guides 16 would have been from the uppermost one of the saw guides 16 (if the user had activated the uppermost one of the saw guides 16 first). The next message received from the saw guides 16 would be from the second uppermost one of the saw guides 16, and so forth. Based on this and based on the identifiers of the saw guides included in the messages, the server 42 may be configured to determine the relative positions and identities of all of the saw guides 16 in the stack 17. The server 42 may also be configured to display the virtual model 92 on the display screen 43 to the user.

Data from one or more of the sensors 40 may be transmitted to the server 42 through messages sent from the transceivers 70. The server 42 is able to determine from which of the saw guides 16 the data is transmitted based, for example, the identifiers of the saw guides 16 included in the messages.

In still another embodiment, the saw guides 16 may use the transceivers 70 to transmit messages to the server 42. However, instead of providing the switches 66 to allow for individual activation of the saw guides 16, the saw guides 16 may be electrically connected together, such as through wiring or some other form of electrical connection among the saw guides 16. Each of the saw guides 16 may be configured to determine its position relative to other ones of the saw guides 16 (e.g. through the electrical connections with other ones of the saw guides 16). Each of the saw guides 16 may be further configured to transmit data (including the relative position of the saw guide 16 within the stack 17 and data from the sensors 40) to the server 42 using the transceivers 70.

The embodiments described herein may allow for faster operational decisions for the saw arbor guide assembly 10 as more accurate data regarding the properties measured by the sensors 40 is available. Furthermore, the embodiments described herein may also reduce and/or eliminate the need for the user to correlate the positions of the saw guides 16, the sensors 40 thereon, and the saw blades 18 within the server 42 during maintenance. Still further, the embodiments described herein may reduce and/or eliminate unreliable wireless communications from wireless sensors to the server 42 and the need for batteries on the saw guides 16.

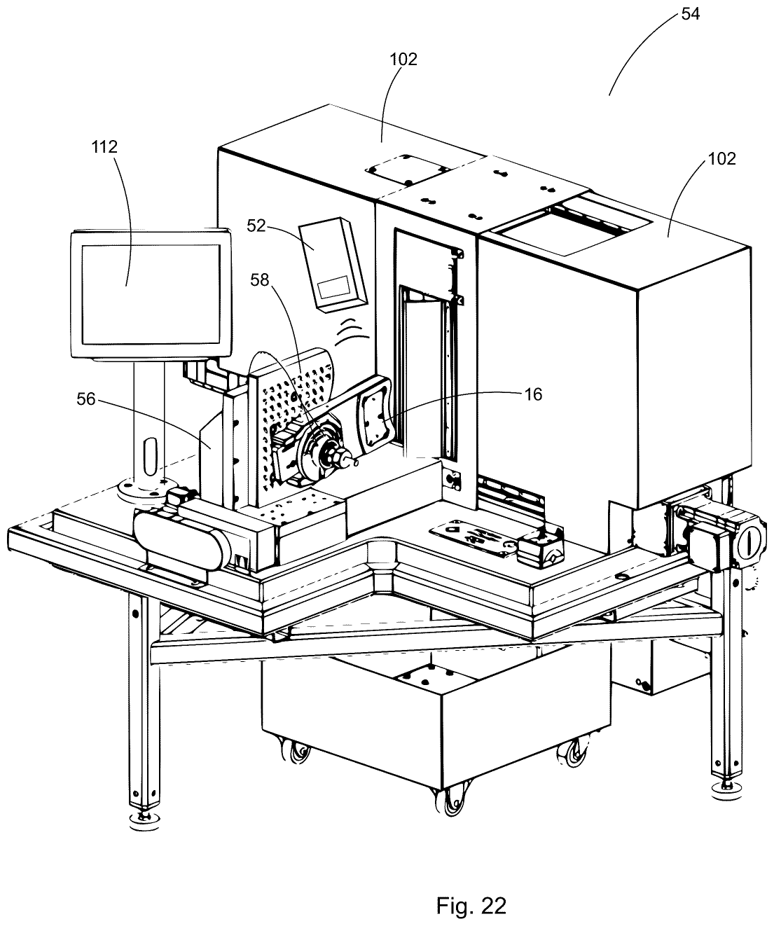

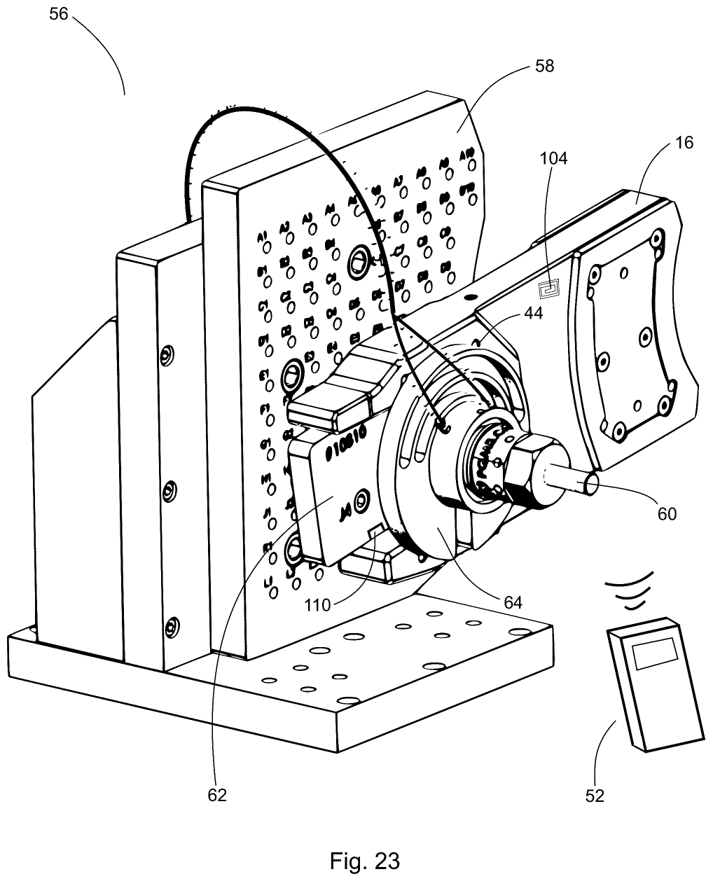

Referring to FIGS. 22 and 23, in yet another embodiment, each of the saw guides 16 may be further configured to communicate with a scanner 52 associated with a guide dresser 54. The guide dresser 54 may be used to machine the surfaces of the saw guides (e.g. the first and second body surfaces 34, 36) to ensure that they are substantially flat and are substantially parallel to each other. The guide dresser 54 comprises a carriage assembly 56, to which the saw guide 16 may be mounted. The carriage assembly 56 comprises a faceplate 58 on which the saw guide 16 may be mounted. The faceplate 58 may be adapted to engage with one of the first and second head surfaces 26, 28 when the saw guide 16 is mounted.

The carriage assembly 56 further comprises a guide locator 62 attached to the faceplate 58. The guide locator 62 may be configured to engage with at least a portion of the collar sidewall 30 and helps to orient the saw guide 16 when mounted on the faceplate 58. A rod 60 extends from or through the faceplate 58. At least a portion of the rod 60 may be threaded. A retaining ring 64 is adapted to fit around the rod 60 and is further adapted to engage against the other one of the first and second head surfaces 26, 28 when the saw guide 16 is mounted. In this manner, the saw guide 16 may be securely held against the faceplate 58 by the retaining ring 64.

The carriage assembly 56 is configured to move the saw guide 16 into position between the cutting assemblies 102, which will cut and machine the first and second body surfaces 34, 36.

In this embodiment, the saw guide 16 mounted to the carriage assembly 56 comprises at least one the connector units 44.

The communication between the connector unit 44 and the scanner 52 may take one of several forms. In some embodiments, the connector unit 44 may communicate with the scanner 52 through direct electrical contact (e.g. a wired connection). By way of example only, the connector unit 44 and the scanner 52 may comprise pin-and-socket connectors that are configured to physically engage with each other and provide a direct communications connection between the connector unit 44 and the scanner 52. Other mechanisms for providing direct contact communications between the connector unit 44 and the scanner 52, such as through other mateable or engagement connections, may also be utilized.

In some embodiments, the guide dresser 54 may comprise a guide dresser server 112 that is configured to control the operations of the guide dresser 54 including, for example, controlling the operations of the cutting assemblies 102 and the movement of the carriage assembly 56 (with the saw guide 16 mounted) out of and in between the cutting assemblies 102. The scanner 52 may be configured to communicate with the guide dresser server 112.

In other embodiments, the connector unit 44 may comprise a transmitter that is configured to wirelessly communicate with the scanner 52, such as through NFC or some other suitable wireless communications protocol. The scanner 52 may comprise a receiver configured to wirelessly communicate with the connector unit 44. In other embodiments, the connector unit 44 may be configured to wirelessly communicate with the scanner 52 through wireless infrared communications.

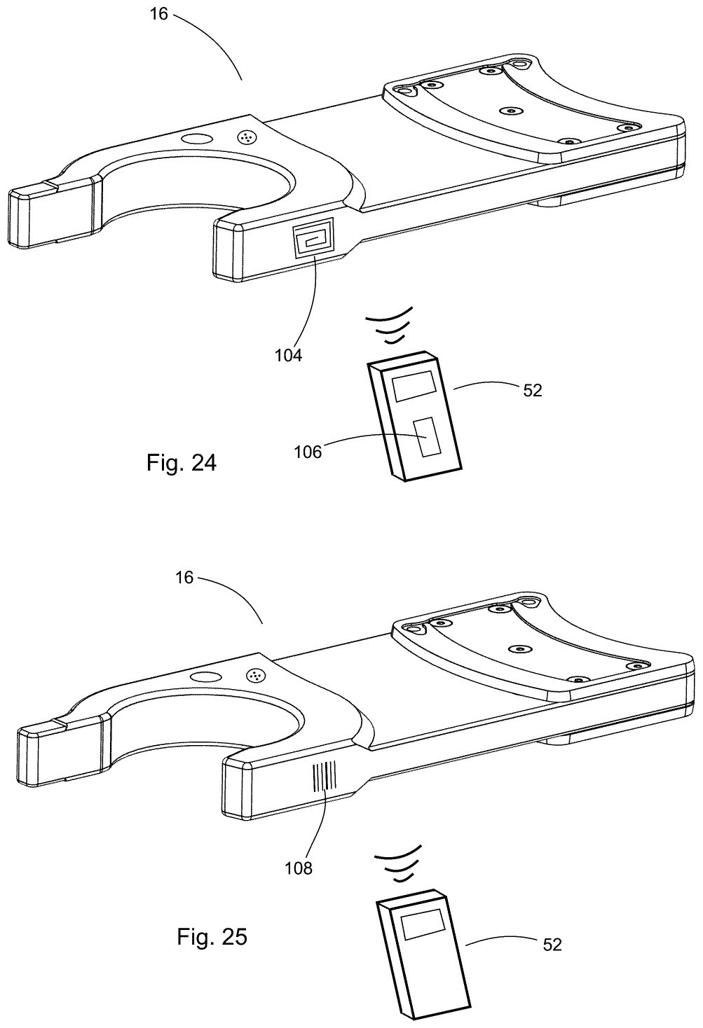

Referring to FIG. 24, in some embodiments, the connector unit 44 may comprise a radio frequency identification (RFID) tag 104. The RFID tag 104 may be located on an exterior of the saw guide 16. In some embodiments, the RFID tag 104 may be located on the body of the saw guide 16, such as on one of the first or second body surfaces 34, 36, as shown in FIG. 23. In other embodiments, the RFID tag 104 may be located on the head of the saw guide 16, such as shown in FIG. 24. The scanner 52 may comprise a RFID reader 106 that is configured to communicate with the RFID tag 104. Referring to FIG. 25, in still other embodiments, instead of providing the connector unit 44, the saw guides 16 may comprise an optical code 108, such as a barcode, a quick-response (QR) code, or some other visual identifier, located on an exterior of the saw guide 16. The optical code 108 may be read by the scanner 52 through optical scanning.

In some embodiments, each of the saw guides 16 may be associated with an identifier. In other embodiments, each of the saw guides 16 may be associated with a particular type, with each type associated with an identifier. When the scanner 52 communicates or otherwise engages with the saw guide 16 (e.g. using the connector unit 14, using the RFID tag 104, etc.), the scanner 52 is able to determine the identifier for the saw guide 16. For example, the identifier may be transmitted using NFC from the saw guide 16 to the scanner 52. Alternatively, the identifier may be transmitted from the RFID tag 104 to the RFID reader 106. Still alternatively, the identifier may be embedded within the optical code 108, with the scanner 52 configured to determine the identifier through optical scanning of the optical code 108.

Through the methods described above, the scanner 52 is able to identify a particular one of (or a particular type of) the saw guides 16 that is mounted to the carriage assembly 56 using the identifier. By identifying the particular one or type of the saw guides 16, the guide dresser server 112 may be configured to set the appropriate parameters and settings for the cutting assemblies 102 and/or the carriage assembly 56 (i.e. the appropriate parameters and settings based, at least in part, on the particular one or type of the saw guides 16 that is about to be machined by the guide dresser 54). Alternatively, the guide dresser server 112 may be configured to ensure that the appropriate parameters and settings for the particular one or type of saw guides 16 has been entered or set by the user.

Furthermore, the guide dresser 54 may comprise one or more dresser connector units 110 that are configured to communicate with the connector units 44 on the saw guide 16 when the saw guide 16 is mounted. The dresser connector units 110 may be located in one or more of the faceplate 58, the guide locator 62, the retaining ring 64, or elsewhere on the carriage assembly 56, depending on the location of the connector units 44 on the saw guide 16. The dresser connector units 110 may be configured to communicate with the connector units 44, either through direct contact communications (e.g. pin-and-socket connectors) or through wireless communications. The dresser connector units 110 may also be configured to communicate with the guide dresser server 112.

Through the communications between the dresser connector units 110 and the connector units 44, the guide dresser server 112 may be configured to determine the identity or type of the saw guide 16 mounted and verify that the correct one or type of the saw guides 16 is mounted. The guide dresser server 112 may also be configured to verify that the correct program for machining the saw guide 16 identified has been loaded. The guide dresser server 112 may also be used to track the service life of the saw guides 16 (e.g. how many times the saw guides 16 has been machined).

It will be appreciated by those skilled in the art that the preferred embodiment has been described in some detail but that certain modifications may be practiced without departing from the principles of the invention.

1. A saw arbor guide assembly comprising
one or more arbors;
one or more guide posts;
a plurality of saw blades arranged about at least one of the one or more arbors;
a plurality of saw guides arranged about at least one of the one or more guide posts to form a stack of saw guides, wherein adjacent ones of the plurality of saw guides are configured to interact with the plurality of saw blades and wherein each of the saw guides comprises:
a head configured to engage with the at least one of the one or more guide posts, the head comprising first and second head surfaces;
a body attached to the head and configured to extend, at least partially, between two of the plurality of saw blades;
a sensor located on the body or the head; and
one or more connector units, the one or more connector units located proximate to one or both of the first and second head surfaces, wherein the one or more connector units are configured to receive data from the sensor, and wherein the one or more connector units are further configured to communicate with other ones of the connector units located on adjacent ones of the saw guides within the stack, the communications comprising the data received from the sensor;
a primary guide manifold and a secondary guide manifold, wherein the primary and secondary guide manifolds are arranged at opposite ends of the stack, wherein each of the primary and second guide manifolds comprises one or more manifold connectors, wherein the one or more manifold connectors on the primary guide manifold are configured to communicate with the one or more connector units on a first one of the saw guides in the stack, and wherein the one or more manifold connectors on the secondary guide manifold are configured to communicate with the one or more connector units on a last one of the saw guides in the stack; and
a server, wherein the server is configured to communicate with the one or more manifold connectors in one or both of the primary guide manifold and the secondary guide manifold.

2. The saw arbor guide assembly of claim 1, wherein each of the saw guides comprises two connector units, wherein a first one of the two connector units is located proximate to the first head surface, and wherein a second one of the two connector units is located proximate to the second head surface.

3. The saw arbor guide assembly of claim 2, wherein the first one of the two connector units is flush with the first head surface, and wherein the second one of the two connector units is flush with the second head surface.

4. The saw arbor guide assembly of claim 1, wherein communications between the one or more connector units and the other ones of the connector units located on the adjacent ones of the saw guides are through a wired connection.

5. The saw arbor guide assembly of claim 4, wherein the wired connection comprises a pin-and-socket connection.

6. The saw arbor guide assembly of claim 1, wherein communications between the one or more connector units and the other ones of the connector units located on the adjacent ones of the saw guides are through a wireless connection.

7. The saw arbor guide assembly of claim 6, wherein the wireless connection uses near-field communications.

8. The saw arbor guide assembly of claim 1, wherein communications between the manifold connectors on the primary guide manifold and the one or more connector units on the first one of the saw guides in the stack are through a wired connection.

9. The saw arbor guide assembly of claim 1, wherein communications between the manifold connectors on the secondary guide manifold and the one or more connector units on the last one of the saw guides in the stack are through a wired connection.

10. The saw arbor guide assembly of claim 1, wherein communications between the manifold connectors on the primary guide manifold and the one or more connector units on the first one of the saw guides in the stack are through a wireless connection.

11. The saw arbor guide assembly of claim 1, wherein communications between the manifold connectors on the secondary guide manifold and the one or more connector units on the last one of the saw guides in the stack are through a wireless connection.

12. The saw arbor guide assembly of claim 1, wherein the server is further configured to generate a virtual model of the stack depicting an ordering of the plurality of saw guides in the stack based, at least in part, on the communications received from the one or more manifold connectors in one or both of the primary guide manifold and the secondary guide manifold.

13. The saw arbor guide assembly of claim 12, wherein the server is further configured to update the virtual model of the stack to include data received from the sensors on each of the plurality of saw guides in the stack.

14. The saw arbor guide assembly of claim 1, wherein the sensor is configured to detect one or more of the following properties: temperature, vibration, and lubricant flow.

15. A saw arbor guide assembly comprising:
an arbor;
a guide post comprising one or more post connectors;
a plurality of saw blades arranged about the arbor;
a plurality of saw guides arranged about the guide post to form a stack of saw guides, wherein adjacent ones of the plurality of saw guides are configured to interact with the plurality of saw blades and wherein each of the saw guides comprises:
a head configured to engage with the at least one of the one or more guide posts;
a body attached to the head and configured to extend, at least partially, between two of the plurality of saw blades;
a sensor located on the body or the head; and
one or more connector units, wherein the one or more connector units are configured to receive data from the sensor, and wherein the one or more connector units are further configured to communicate with one of the one or more post connectors when the plurality of saw guides are arranged in the stack, the communications comprising the data received from the sensor; and
a server, wherein the server is configured to communicate with the one or more post connectors.

16. The saw arbor guide assembly of claim 15, wherein the server is further configured to generate a virtual model of the stack depicting an ordering of the plurality of saw guides in the stack based, at least in part, on the communications received from the one or more post connectors.

17. The saw arbor guide assembly of claim 16, wherein the server is further configured to update the virtual model of the stack to include data received from the sensors on each of the plurality of saw guides in the stack.

18. A method for operating a guide dresser, the method comprising:
mounting a saw guide onto the guide dresser;
providing a transmitter on an exterior of the saw guide,
transmitting, by the transmitter, an identifier for the saw guide;
receiving, by a scanner, the identifier;
communicating, by the scanner, the identifier to a guide dresser server configured to control operations of the guide dresser; and
verifying, by the guide dresser server, of the settings for operating the guide dresser based, at least in part, on the identifier.

19. The method of claim 18, wherein the transmitter comprises a radio frequency identification (RFID) tag.

20. The method of claim 19, wherein the scanner comprises a RFID receiver.
